(19) United States
(12) Patent Application Publication
(10) Pub. No.: US 2011/0179545 A1
(43) Pub. Date: Jul. 28, 2011

(54) Wearable Bottle Cap Remover

(76) Inventor: Jason Victor Rummel, Sharon, PA (US)

(21) Appl. No.: 12/695,468

(22) Filed: Jan. 28, 2010

(51) Int. Cl. A41D 1/00; A41D 27/00; B25F 1/00

(52) U.S. Cl. 2/69; 2/243.1; 7/151

(57) ABSTRACT

The invention provides a garment that incorporates a bottle opener permanently attached at a convenient place on the garment so that the wearer can carry the opener on his person and utilize it when desired.

### BRIEF DESCRIPTION OF THE DRAWINGS

FIG. 1 shows examples of a garment having a bottle cap attached thereto.

FIG. 2 is a view of a garment having an attached bottle cap remover as seen from the inside of the garment and showing a patch of durable fabric on which the bottle cap remover is mounted.

Wherein

10 is the garment

12 is the logo or advertisement on the outside of the garment in the area where the bottle cap opener is attached

14 is the bottle opener

16 is a reinforcing patch on which the bottle opener is mounted inside the garment.

### DETAILED DESCRIPTION OF THE INVENTION

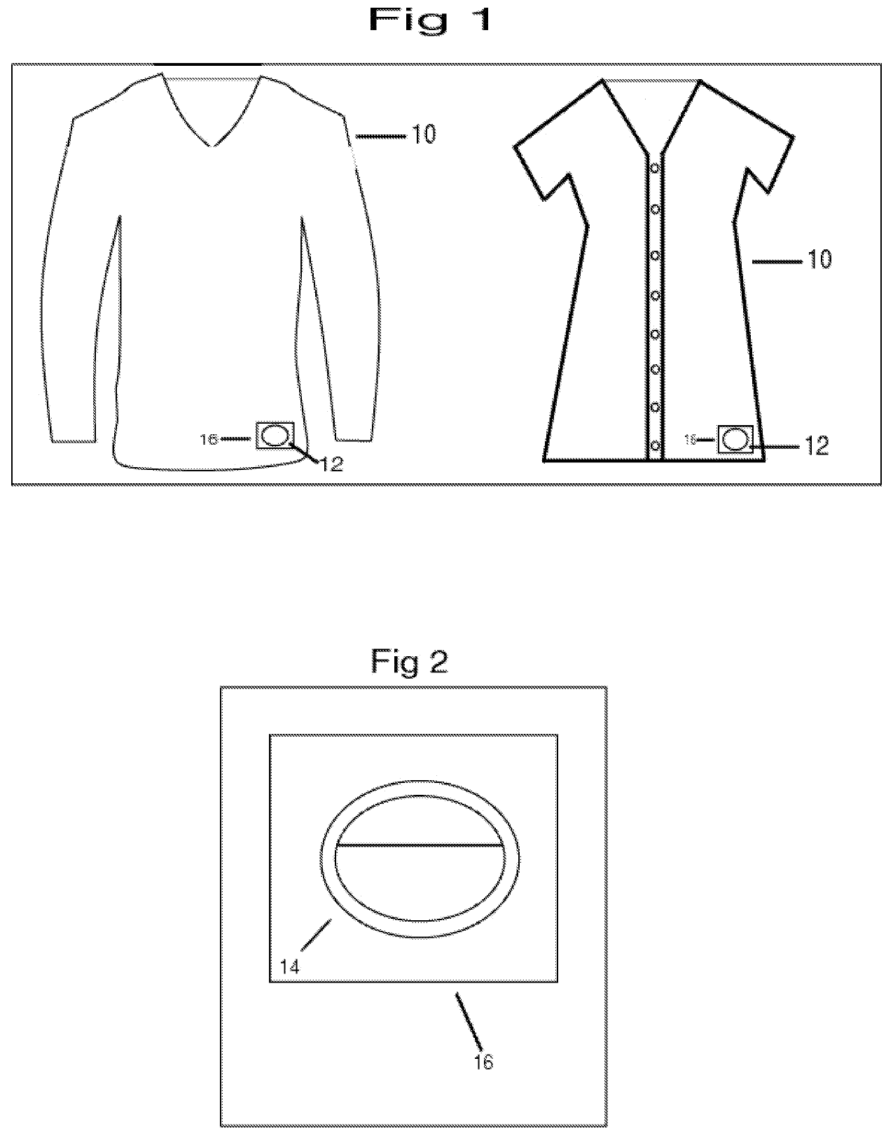

The invention improves the idea of using a bottle cap opener because it is sewn or otherwise attached into a garment 10. The bottle opener can be attached to appropriate exterior garments similar to those described in the preferred embodiment, for example, blouses, shirts, jerseys jackets, and other garments substantially similar to those illustrated in FIGS. 1 and 2.

This clothing device 10 has a thin, round steel, metal, or plastic bottle cap opener 14 incorporated into the shirt, jersey, blouse, etc. The bottle cap opener 14 can be sewn into the garment like a button is placed into a jacket. For added strength the bottle cap opener can be sewn into a stronger square patch 16, which would also be incorporated into the garment 10. There can also be a design, logo, or advertisement 14 printed on the front side of the bottle cap opener.

The shirt, jersey, skirt or blouse necessarily will have the bottle cap sewn or securely attached into it. A stronger square or circular patch 16 can be sewn into the selected clothing to allow the bottle cap opener to have a more secure fit. The bottle cap opener 14 could be sewn into the middle of the patch 16.

The relationship between components is very relevant to each other. Bartenders to bottle drinkers will have the luxury of having the bottle opener 14 at hand in the garment 10 they are wearing to work, party, or even at home.

Placing the bottle opener device into the clothing will allow a person to conveniently remove the bottle cap from a bottle. The bottle cap opener 14 can be sewn into several different garments including jerseys, shirts, skirts, and blouses as shown in FIG. 1. Also a logo, design, or advertisement 12 can be printed on the front of the bottle cap opener as shown in FIG. 1. The invention would be made by a clothing manufacture in the process of making the garment.

To use the device a person would place the bottle inside the clothing bottle opener device 14 then twist the cap to remove it.

The invention solves the problem of people losing their bottle cap openers. It also allows the average bar tender, college student or other user to open the bottle without misplacing the bottle cap opener. The invention also makes an easier more stylish or “cooler” way of opening a bottle. The bottle cap opener is sewn or otherwise attached into the bottom left or right hand side of a shirt, sweatshirt, jersey, blouse or other garment. The user simply places the bottle into the bottle cap opener and opens the bottle.

What is claimed is:

1. A garment for exterior wear having attached thereto in a stable manner a bottle opener, said opener placed conveniently on said garment for use by the wearer.
